(19) United States
(12) Patent Application Publication
(10) Pub. No.: US 2005/0200220 A1
(43) Pub. Date: Sep. 15, 2005

(54) Electromagnetic motor employing multiple rotors

(76) Inventor: Carl Larue Godfrey, San Juan Capistrano, CA (US)

Correspondence Address: STETINA BRUNDA GARRED & BRUCKER, 75 ENTERPRISE, SUITE 250, ALISO VIEJO, CA, 92656, US

(21) Appl. No.: 11/119,983

(22) Filed: May 2, 2005

Related U.S. Application Data
(63) Continuation of application No. 10/413,761, filed on Apr. 15, 2003.

(51) Int. Cl. H02K 53/00

(52) U.S. Cl. 310/113; 310/156.42

(57) ABSTRACT

An electromagnetic motor employing plural rotors is provided, with each rotor exhibiting a permanent magnetic field. A control module selectively induces magnetic fields in electromagnetic pads surrounding each of the rotors. Through the interaction of the permanent and induced magnetic fields, the rotors can turn. As a result, a shaft mechanically engaging the rotors also turns to provide mechanical power. In response to the shaft rotation, an alternator generates sufficient electrical power to sustain the operation of the control module without an external power source. The magnetic polarities of the induced magnetic fields can be reversed, thus causing the rotors to continue turning. In various applications, the motor can be installed in a vehicle or in a building power supply as desired.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to power generation, and more particularly to the generation of mechanical and electrical power using electromagnetic principles.

As is well known in the art, various methods exist for generating mechanical and electrical power. Such prior methods include combustion, solar power, water power, and others. Unfortunately, these power generation methods exhibit various negative consequences. For example, the internal combustion engine is commonly used to power vehicles and meet the transportation needs of much of the world. However, its widespread use has resulted in pollution and depletion of fossil fuels. Clearly, alternatives to prior art power generation methods are highly desirable.

As is also well known, electromagnets are often employed to operate electric motors, alternators, generators, and other machines. Electromagnets have also been used in industry, as evidenced by the large electromagnets at work in automotive and metal recycling yards.

Through the application of electromagnetic principles, the present invention provides an alternative method and apparatus for generating mechanical and electrical power.

### BRIEF SUMMARY OF THE INVENTION

The present invention, roughly described, provides a motor that operates in accordance with a unique application of electromagnetic principles. The electromagnetic motor of the present invention includes plural rotors, with each rotor exhibiting a permanent magnetic field. A control module is provided which can selectively induce magnetic fields in a plurality of electromagnetic pads encircling the rotors. Interaction between the permanent and induced magnetic fields cause the rotors to turn, thereby rotating a shaft mechanically engaging the rotors. An alternator is mechanical communication with the shaft generates electrical power which sustains the operation of the control module without an external power source.

In various embodiments, the control module is capable of selectively reversing polarities of the induced magnetic fields upon partial turning of the rotors, thereby causing the shaft to continuously rotate. An electromagnetic motor in accordance with the present invention can be installed in a motor vehicle, providing mechanical power to propel the vehicle and electrical power to charge the vehicle's battery. In another embodiment, the motor can be installed in a building power supply. Storage cells providing electrical power to a building can be recharged by an alternator operating in conjunction with the motor.

These and other embodiments of the present invention are discussed in further detail below.

### BRIEF DESCRIPTION OF THE DRAWINGS

FIG. 1 provides a cross-sectional view of a portion of an electromagnetic motor in accordance with an embodiment of the present invention.

FIG. 2 provides a block diagram of a vehicle utilizing an electromagnetic motor in accordance with an embodiment of the present invention.

FIG. 3 provides a cross-sectional view of multiple rotors of an electromagnetic motor in accordance with an embodiment of the present invention.

FIG. 4 provides a block diagram of a home electrical power supply employing an electromagnetic motor in accordance with an embodiment of the present invention.

FIG. 5 provides a perspective view of a home electrical power supply employing an electromagnetic motor in accordance with an embodiment of the present invention.

FIG. 6 provides a side view of a home electrical power supply employing an electromagnetic motor in accordance with an embodiment of the present invention.

### DETAILED DESCRIPTION OF THE INVENTION

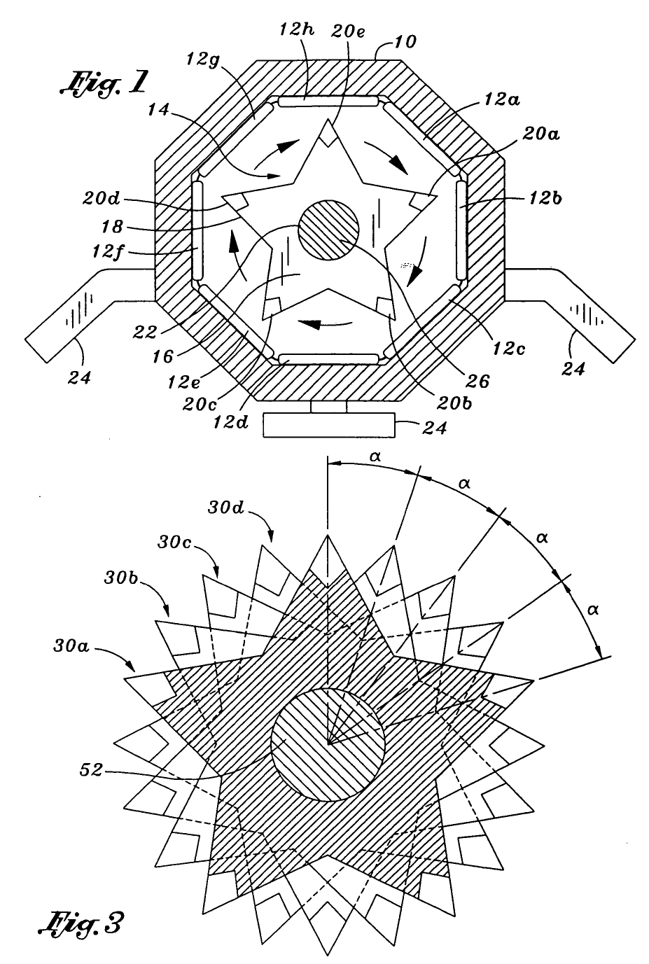

FIG. 1 provides a cross-sectional view of a portion of an electromagnetic motor in accordance with an embodiment of the present invention. The components set forth in FIG. 1 serve to illustrate several of the operational principles of the motor.

Rotor 14 comprises a hub 16, aperture 22, and five coplanar arm members 18 projecting outwardly from the hub 16. Arm members 18 are uniformly distributed around a perimeter of the hub 16 in a star-shaped configuration. In order to dissipate heat, rotor 14 can be made from graphite ceramic composite material. It will be appreciated that, while the structure of rotor 14 bears certain similarities to the Wankel rotary engine, the present invention operates in accordance with electromagnetic principles rather than combustion or compression.

Rotor tips 20a-e are permanent magnetic field sources provided on the distal ends of arm members 18. The rotor tips 20a-e are oriented such that exterior portions of each of the rotor tips 20a-e exhibit the same magnetic polarity projecting outwardly from arm members 18. In one embodiment, these exterior portions exhibit a “north” magnetic polarity. Rotor tips 20a-e can be made from any suitable magnetic material, such as iron-ore (i.e. stainless steel). In the manufacture of rotor 14, each of the rotor tips 20a-e can be inserted into an arm member 18 and then adhered to the arm member 18 with resin or other suitable adhesive.

Shaft 26 is mechanically engaged with rotor 14 through aperture 22. As a result of this engagement, shaft 26 will turn with rotor 14. Shaft 26 can be made from non-ferrous material such as graphite or carbon fiber in order to minimize the effects of magnetic fields on the shaft.

By way of preferred embodiment and not by way of limitation, a plurality and preferably eight electromagnetic pads 12a-h are arranged in a ring configuration encircling rotor 14. As further described herein, magnetic fields of various polarities can be selectively induced in pads 12a-h to turn rotor 14. To facilitate this electromagnetic operation, each of pads 12a-h can be comprised of molded ceramic material with iron composite plates embossed within the face of each pad.

Pads 12a-h and rotor 14 are surrounded by a housing 10. Housing 10 can be made from aluminum in order in order to insulate the interior components from outside magnetic flux. A plurality of mounts 24 are also provided for securing the motor of FIG. 1.

The following example illustrates the operational principles of the present invention by considering the functionality of rotor tips 20a-b in relation to pads 12a-d. As explained above, each of rotor tips 20a-b exhibits a permanent magnetic field with the same magnetic polarity (“first polarity”) directed toward pads 12a-d. As also described above, magnetic fields can be selectively induced in each of pads 12a-d.

Specifically, magnetic fields can be induced in pads 12a and 12c such that surfaces of these pads facing rotor 14 exhibit the same first polarity as rotor tips 20a-b. Similarly, magnetic fields can be induced in pads 12b and 12d such that surfaces of these pads facing rotor 14 exhibit an opposite polarity (“second polarity”).

While these magnetic fields are induced, the interaction between the first and second polarities will cause rotor 14 to turn. Specifically, pads exhibiting the first polarity will repel the rotor tips, and pads exhibiting the second polarity will attract the rotor tips. As a result, rotor tips 20a-b will be repelled from pads 12a and 12c. Meanwhile, rotor tips 20a-b will be attracted toward pads 12b and 12d. This “push-pull” effect of repulsion and attraction between rotor tips 20a-b and pads 12a-d will cause rotor 14 to turn as indicated by the clockwise arrows of FIG. 1. As a result, shaft 26 will also rotate.

After rotor 14 has partially turned in response to these magnetic interactions, rotor tip 20a will be adjacent to pad 12b, and rotor tip 20b will be adjacent to pad 12d. In order to continue the turning of rotor 14 in the clockwise direction, the polarities of the magnetic fields induced in pads 12a-d are reversed. Thus, the polarities of pads 12a and 12c are changed from the first polarity to the second polarity. Similarly, the polarities of pads 12b and 12d are changed from the second polarity to the first polarity. As a result, rotor tip 20a will be repelled from pad 12b and attracted toward pad 12c. Similarly, rotor tip 20b will be repelled from pad 12d.

It will be appreciated that these operational principles can be applied to all rotor tips 20a-e and pads 12a-h of FIG. 1. Thus, magnetic fields of differing polarities can be selectively induced in any of pads 12a-h in order to attract and repel any of the rotor tips 20a-e as desired. For example, magnetic fields of different polarities can be induced in each of the adjacent pads 12a-h, with a first set of pads exhibiting a first polarity (i.e. pads 12a, 12c, 12e, and 12g) and a second set of pads exhibiting a second opposite polarity (i.e. pads 12b, 12d, 12f, and 12h). By selectively inducing magnetic fields in the pads and reversing their polarities, rotor 14 can continue turning in accordance with the principles set forth above. As a result, shaft 26 will also rotate.

It will be appreciated that stronger attraction and repulsion of the rotor tips 20a-e can result from increasing the voltages used to induce the magnetic fields set forth above (for example, the voltages used to induce magnetic fields in pads 12a-h can be increased). It will also be appreciated that, although a clockwise rotation is illustrated in FIG. 1, embodiments employing a counterclockwise rotation are also contemplated.

In one embodiment, a clearance of approximately ⅜ inches is maintained between the rotor tips and pads when no magnetic fields are induced in the pads, and a clearance of approximately ⅛ inches is maintained between rotor tips and pads exhibiting opposite magnetic polarities.

Although FIG. 1 illustrates a single rotor 14, it will be appreciated that an electromagnetic motor in accordance with the present invention preferably employs a plurality of four rotors mechanically engaged with a shaft. Each rotor is encircled by eight electromagnetic pads. The four rotors are offset from each other in the range of approximately 16-18 degrees. Rotors can be added to the shaft in additional sets of four to increase torque on the shaft.

It is estimated that various embodiments of an electromagnetic motor in accordance with the present invention can provide a maximum torque of approximately: 200 ft-lb (using four rotors), 400 ft-lb torque (using eight rotors), and 600 ft-lb torque (using twelve rotors).

In various embodiments, the rotors of an electromagnetic motor in accordance with the present invention run between approximately 24,000 to 32,000 RPM, exhibiting frictional losses of approximately 12-15%. Such frictional losses can be offset by inducing stronger magnetic fields in the electromagnetic pads.

It is contemplated that an electromagnetic motor in accordance with the present invention can be used to supply electrical and/or mechanical power in any appropriate civilian and/or military environment. For example, such an electromagnetic motor can be used in motor vehicles.

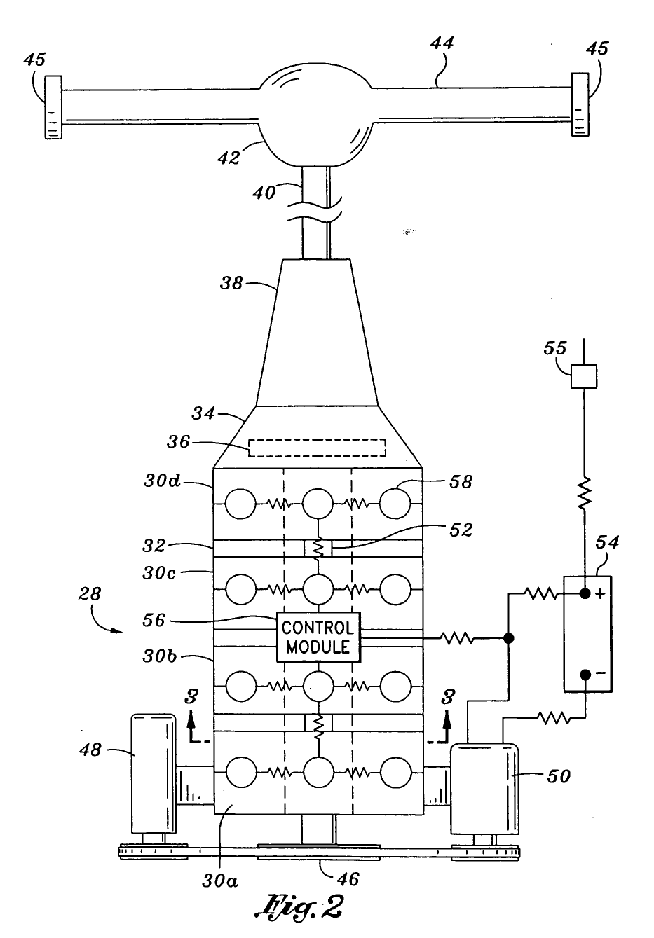

FIG. 2 provides a block diagram of a vehicle utilizing an electromagnetic motor in accordance with an embodiment of the present invention. As illustrated in FIG. 2, the vehicle incorporates many of the traditional components associated with conventional motor vehicles such as: a bellhousing 34, flywheel 36, transmission 38, driveline 40, differential 42, rear drive axle 44, wheels 45, belt pulley 46, and rotary air compressor 48. However, in place of a conventional internal combustion engine, the electromagnetic motor 28 of the present invention is provided.

Motor 28 includes four rotors 30a-d mechanically engaging a shaft 52. Electromagnetic pads 58 are arranged in a plurality of rings, with each ring providing eight pads that encircle one of the rotors 30a-d. Each of the rotors 30a-d can be implemented in the manner illustrated in FIG. 1, with eight pads surrounding each rotor, and the tips of each rotor exhibiting a first permanent magnetic polarity. A housing 32 is also provided for enclosing rotors 30a-d, pads 58, and shaft 52.

Control module 56 is in electrical communication with each of pads 58 for selectively inducing magnetic fields in the pads 58 in accordance with the operational principles described above with regard to FIG. 1. By selectively inducing these magnetic fields, control module 56 can cause rotors 30a-d to turn at a desired RPM.

Shaft 52 is caused to rotate in response to the turning of rotors 30a-d caused by the magnetic fields induced in pads 52 by control module 52. This rotation of shaft 52 provides mechanical power to transmission 38, driveline 40, and related components illustrated in FIG. 2 in order to propel the vehicle. Appropriate apparatus can be provided to gear down the relatively high RPM of shaft 52 to run driveline 40 at an appropriate lower RPM. Shaft 52 also provides mechanical power to turn belt pulley 46, air compressor 48, and high output alternator 50.

Alternator 50 is turned by belt pulley 46 which is in mechanical communication with shaft 52. Electrical power generated by alternator 50 is provided to control module 56 and battery 54. In one embodiment, battery 54 is a 24 VDC battery.

To start the motor 28, ignition switch 55 causes battery 54 to supply electrical power to control module 56 to initiate the turning of rotors 30a-d. In one embodiment, the battery voltage is converted to a minimum of 10 kV through an ignition coil in order to start the motor 28. After motor 28 has started, electrical power generated by alternator 50 sustains the operation of the control module without an external power source. Alternator 50 also charges battery 54 as necessary.

FIG. 3 provides a cross-sectional view of rotors 30a-d taken at line 3-3 of FIG. 2. As illustrated in FIG. 3, each of rotors 30a-d are offset from each other by an angle alpha. In one embodiment, alpha is in the range of approximately 16 to 18 degrees. As a result of this offset, at least one of rotors 30a-d will always be on a “power stroke,” being simultaneously pushed and pulled by magnetic fields induced in pads 58.

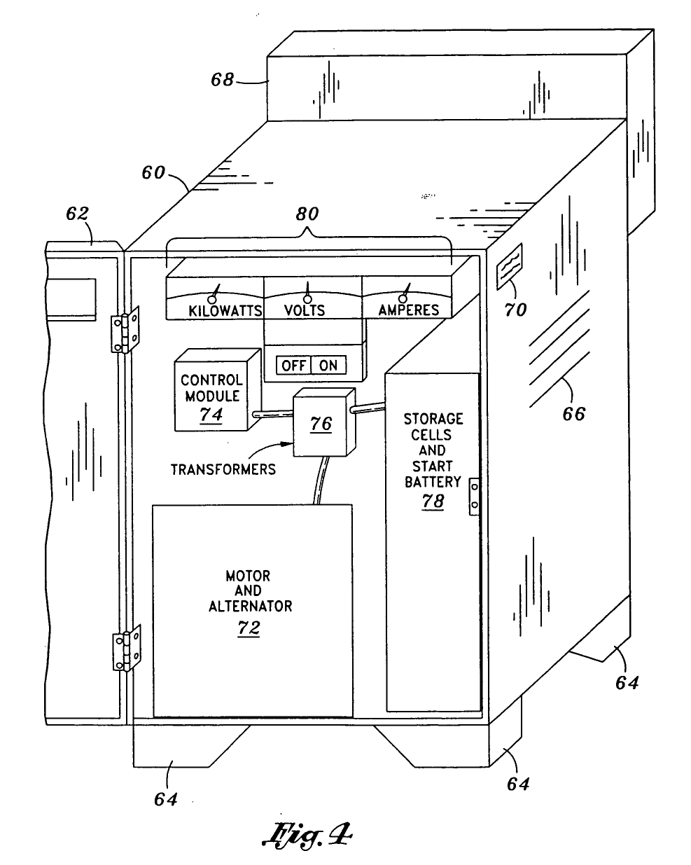

An electromagnetic motor in accordance with the present invention can also be used to supply electrical power to a building or home. FIG. 4 provides a block diagram of a home electrical power supply employing an electromagnetic motor in accordance with an embodiment of the present invention. It is contemplated that the power supply of FIG. 4 can be conveniently installed in the interior of a home, such as a garage.

The power supply of FIG. 4 includes an electromagnetic motor and alternator 72 which employ the operational principles described above. A combination of storage cells and start battery 78 are also provided, and are in electrical communication with control module 74 and motor/alternator 72 through transformer box 76. In one embodiment, cells/battery 78 comprise two primary storage cells and one start battery. The start battery is used to initiate operation of restart motor/alternator 72 when necessary. The storage cells are recharged through the periodic operation of motor/alternator 72. Each storage cell can be implemented with sufficient capacity to supply electrical power to a typical home for approximately ninety days.

A control module 74 is provided for inducing magnetic fields in electromagnetic pads of the motor 72, as previously described herein. Control module 74 is in electrical communication with motor/alternator 72 and cells/battery 78 through transformer box 76. Control module 74 detects when the storage cells are sufficiently drained, and causes the motor/alternator 72 to be restarted using the start battery in order to recharge the storage cells. Control module 74 monitors the charging of cells/battery 78 during the operation of motor/alternator 72. When the cells/battery 78 are fully charged, control module 74 shuts down motor/alternator 72.

Transformer box 76 provides a first transformer for converting the high output voltage of motor/alternator 72 to a low voltage supplied to cells/battery 78. The first transformer can be implemented to convert approximately 880 VAC received from motor/alternator 72 to a lower DC voltage provided to cells/battery 78.

Transformer box 76 further provides a second transformer and a rectifier operating together to convert a low DC voltage from the storage cells to a higher AC voltage to be supplied to a home. The second transformer and rectifier can be implemented to convert DC voltage provided by cells/battery 78 to approximately 220 VAC which is supplied to the home.

As illustrated in FIG. 4, a plurality of gauges 80 are also provided for measuring various aspects of the operation of the power supply as illustrated in FIG. 4. A fuse panel 68 is also provided, permitting convenient user access for troubleshooting purposes.

A housing 60 and door 62 enclose the components described above. In order to dissipate heat from the power supply of FIG. 4, air vents 66 are provided in housing 60. A certification tag 70 is also provided on housing 60 to specify information pertaining to the power supply, such as the model number and certificate. Anchors 64 are used to secure the housing 60 to a floor surface. In one embodiment, the exterior dimensions of the housing 60 are approximately: 48 inches wide, 60 inches tall, and 36 inches deep.

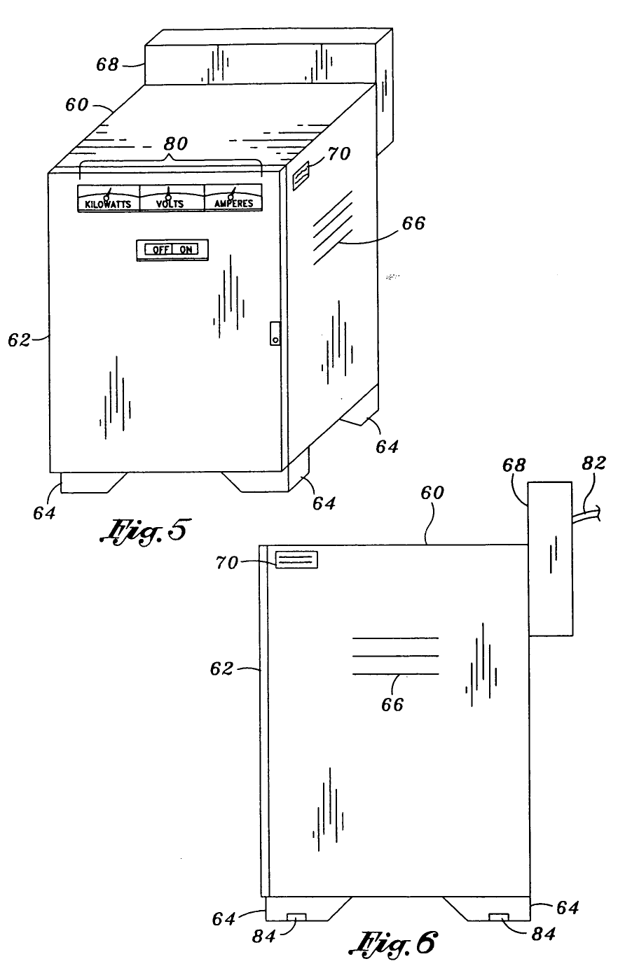

FIGS. 5 and 6 provide perspective and side views, respectively, of the home electrical power supply of FIG. 4. As illustrated in FIG. 6, output wires 82 are provided from fuse panel 68 to provide electrical power supplied by the storage cells through transformer box 76 to a home. As also illustrated in FIG. 6, a plurality of bolts 84 are used to secure the home power supply to a floor surface.

It will be appreciated that the scope of the present invention is not limited by the particular embodiments set forth herein. Other appropriate variations, whether explicitly provided for or implied, are contemplated by the present disclosure.

1. An electromagnetic motor, comprising:
a plurality of rotors, wherein each of said rotors comprises:
a hub portion,
an aperture in said hub,
a plurality of coplanar arm members projecting outwardly from said hub, and
a permanent magnetic field source in each of said arm members causing a permanent magnetic field to be exhibited from a distal end of each of said arm members;
a plurality of electromagnetic pads arranged in a plurality of rings, wherein each ring encircles one of said rotors;
a shaft mechanically engaging said rotors through said apertures;
a control module in electrical communication with said pads for selectively inducing magnetic fields in said pads, said rotors capable of turning in response to interaction between said permanent magnetic fields and said induced magnetic fields, thereby rotating said shaft; and
an alternator in mechanical communication with said shaft for generating electrical power from said rotating of said shaft.

2-18. (canceled)

19. The electromagnetic motor of claim 1, wherein said electrical power sustains the operation of said control module without an external power source.

20. The electromagnetic motor of claim 19, wherein said control module is capable of selectively reversing polarities of said induced magnetic fields upon partial turning of said rotors, thereby causing said shaft to continue rotating.

21. The electromagnetic motor of claim 19, wherein said plurality of rotors comprises four rotors offset approximately 18 degrees from each other.

22. The electromagnetic motor of claim 19, wherein said arm members are uniformly distributed around a perimeter of said hub portion.

23. The electromagnetic motor of claim 22, wherein said plurality of arm members comprises five arm members.

24. The electromagnetic motor of claim 19, wherein each of said rings comprises eight electromagnetic pads.

25. The electromagnetic motor of claim 19, wherein:
said motor is installed in a motor vehicle,
said rotating of said shaft provides mechanical power to propel said vehicle, and
said electrical power provided by said alternator further charges a start battery of said vehicle.

26. The electromagnetic motor of claim 19, wherein:
said motor is installed in a building power supply, and
said electrical power provided by said alternator further charges a plurality of storage cells for supplying said electrical power to said building.

27. A method for generating power, comprising:
providing a plurality of rotors, each of said rotors exhibiting a permanent magnetic field;
providing a shaft mechanically engaging said rotors;
providing a plurality of electromagnetic pads arranged in a plurality of rings, wherein each ring encircles one of said rotors;
inducing a first plurality of magnetic fields in a first set of said pads, wherein said first pads exhibit a first magnetic polarity toward said rotors;
inducing a second plurality of magnetic fields in a second set of said pads, wherein said second pads exhibit a second magnetic polarity toward said rotors;
permitting said rotors to turn in response to interaction between said permanent and induced magnetic fields, thereby rotating said shaft; and
generating electrical power in response to said rotation of said shaft.

28. The method of claim 27, wherein said electrical power is sufficient to perform said inducing steps without an external power source.

29. The method of claim 28, wherein each of said rotors comprises:
a hub portion;
an aperture in said hub;
a plurality of coplanar arm members projecting outwardly from said hub; and
a permanent magnetic field source in each of said arm members causing said permanent magnetic field of each of said rotors, wherein distal ends of each of said arm members exhibit said first magnetic polarity.

30. The method of claim 29, wherein said interaction comprises:
repelling a first set of said arm members from said pads exhibiting said first magnetic polarity, thereby causing said rotors to turn away from said first pads; and
attracting a second set of said arm members to said pads exhibiting said second magnetic polarity, thereby causing said rotors to turn toward said second pads.

31. The method of claim 30, further comprising:
reversing said induced magnetic fields after said rotors have partially turned, wherein said first pads exhibit said second magnetic polarity toward said rotors, and said second pads exhibit said first magnetic polarity toward said rotors; and
permitting said rotors to continue turning in response to interaction between said permanent and induced magnetic fields, thereby causing said shaft to continue rotating.

32. The method of claim 31, wherein said plurality of rotors comprises four rotors offset approximately 18 degrees from each other.

33. The method of claim 31, wherein said arm members are uniformly distributed around a perimeter of said hub portion.

34. The method of claim 33, wherein said plurality of arm members comprises five arm members.

35. The method of claim 31, wherein each of said rings comprises eight electromagnetic pads.

36. The method of claim 31, wherein:
said rotation of said shaft provides mechanical power to propel a vehicle, and
said electrical power further charges a start battery of said vehicle.

37. The method of claim 31, wherein said electrical power further charges a plurality of storage cells for supplying said electrical power to a building.
